(19) United States
(12) Patent Application Publication
(10) Pub. No.: US 2023/0204189 A1
(43) Pub. Date: Jun. 29, 2023

(54) BACKLIGHT ILLUMINATOR FOR MOLDED BODY

(71) Applicants: Satoshi TSURUSAKI, Fukuoka (JP); Kyouko OKANO, Fukuoka (JP)

(72) Inventors: Satoshi TSURUSAKI, Fukuoka (JP); Kyouko OKANO, Fukuoka (JP)

(21) Appl. No.: 16/469,844

(22) PCT Filed: Dec. 15, 2016
(86) PCT No.: PCT/JP2016/087387

§ 371 Date: Jul. 15, 2019

(51) Int. Cl. F21V 7/00; F21V 5/04; A47G 33/00

(52) U.S. Cl. CPC F21V 7/0008; F21V 5/04; A47G 33/00; F21Y 2115/10

(57) ABSTRACT

A backlight illuminator system involving a molded body produces a light illustration atmosphere by combining, with the molded body, an irradiation spectrum of indirect light composed of backlight from a rear projection plate behind a molded body, and which shows the features of the molded body with the faint backlight and defines the contour of the molded body. This backlight illumination system for a molded body includes: the molded body having a forward face, an illumination element provided toward the rear side of the molded body and which illuminates a back face of the molded body; a light transmitting through-hole that is in a rearward irradiation direction of the illuminating body; and a rear projection plate disposed away from the back face/rear side and the illuminating element and which is larger than the outer form of the molded body. The light irradiated onto the rear projection plate from the illumination element defines the contour of the molded body as a backlight reflected from the rear projection plate and the front side of the molded body due to the backlight.

### CROSS REFERENCE TO RELATED APPLICATIONS

This application relates to, and claims priority from Ser. No.:PCT/JP2016/087387 filed Dec. 15, 2016, the entire contents of which are fully incorporated herein by reference.

### FIGURE SELECTED FOR PUBLICATION

FIG. 4

### BACKGROUND OF THE INVENTION

### Field of the Invention

The present invention relates to a backlight illumination (aureole) system for a molded body such as a Virgin Mary statue, a Buddha statue, a statue of human or an animal, and specifically relates in combination to a backlight illuminator that illuminates a rear plane (rear side) of the molded body (statue) using a light source provided behind the molded body.

### Description of the Related Art

Conventionally, for example, as one case of molded body illumination, there is a technology that may be used with a Buddha statue, in which a backlight device arranged behind the Buddha statue comprises an illumination source that illuminates backlight to represent backlighting of the Buddha statue through light and back circumference of the molded body of the Buddha statue and the like, and thereby it is brought forth fantastic and religious atmosphere in which the backlight is added to the Buddha statue itself (for example, PTL1).

Further, there is a technology that light from the inside of the molded body illuminates in all directions of a rear wall plane from many through-holes formed in all circumference of wall plane of the molded body and lights from the through-holes are visualized and projected on the rear wall plane, thereby pleasure of light image as lamp shade is given (for example, PTL 2).

A combination of the molded body and light is a keynote for such conventional technologies and such technologies have been developed based on various technical standpoints, i.e., where the light comes from, which means is used for lighting and how the object (molded body) is being visualized.

### CITATION LIST

### Patent Literature

PTL 1: Japanese Patent Application Laid-open No. H8(1996)-173305
PTL 2: Japanese Patent Application Laid-open No. H5(1993)-205509

### PTL 3: Japanese Patent Application Laid-open No. 2009-181903

### ASPECTS AND SUMMARY OF THE INVENTION

### Technical Problem

However, in the conventional molded body of such as the Buddha statue disclosed in PTL 1 utilizing the backlight, a severity of the Buddha statue is only given to a viewer by changing an atmospheric variation of the Buddha statue and/or a backlight aspect by means of a light illumination of backlight of the Buddha statue.

Further, PTL 3 discloses a technology in which an illumination source lamp is built in the hollow lamp shade on which the through-holes for lights are formed, and by which beauty of the lamp shade itself is given on light radiation in all directions and a light dance due to projecting light illumination from the through-holes on the surrounding wall becomes pleasurable.

However, according to the above technology, although a viewer can visually enjoy a dispersing light and an illumination light on the rear blocking wall plane, the viewer cannot enjoy a constitution of collaboration with light giving religious and spiritual molding to the shape of the molded body and giving an impression of significance included in the shape of the molded body in harmony with light to a viewer, especially a constitution of collaboration with counter light ray (e.g., aureole).

Specifically, the technology of PTL 3 is not more than a technology emphasizing a point to solely enjoy light projected image. Therefore, the purpose of such technology ends at providing only the viewer with spectating and enjoying a variety of changes of lights.

As mentioned earlier, the conventional technologies fail to provide the viewer with a religious and spiritual significance exhibited by the molded body through collaboration with light.

An object of the present invention is to provide a backlight illumination system for a molded body (statue) by which an unconventional and distinctive light-atmosphere is brought forth to the molded body by combining an indirect light illumination comprising backlight rays projected from a rear projection plate to the molded body having a religious aspect and the aspect (e.g., an face-expression) of the molded body is projected by the fainted backlight rays and the whole outline of the molded body emerges, so that the solemn atmosphere from the molded body is brought forth by light and the exceeding atmosphere aspect expected more than that the molded shape provides can be provided.

### Solution to Problem

The invention relates to a backlight illuminator system, for a molded body, comprising: a molded body that is facing a frontside; an illumination element that is arranged behind the molded body and illuminates a backside of the molded body; a light-through-hole that is arranged in a backward or rear illumination direction from the illumination element; and a backside projection plate is larger than an outline of the molded body and is arranged far behind the illumination element a to project light irradiated from the illumination element; wherein light rays irradiated onto the backside projection plate from the illumination element emerges a whole outline of the molded body as backlight ray of reflection light from the backside projection plate, and wherein a frontside of the molded body is visually impressed providing an aspect of solemn atmosphere in association with the backlight ray.

A backlight illumination system for a molded body according to another claim of the present invention, comprises: a molded body that is facing a frontside; an illumination element that is arranged behind the molded body and illuminates a backside of the molded body; a backside projection plate that is larger than an outline of the molded body and is arranged far behind the illumination element to project light irradiated from the illumination element; wherein a groove portion with a predetermined shape is formed on the rear of the molded body, and wherein a light emitting tube in which LED chips are built in a hollow tube at regular intervals is embedded in the groove portion and a heat dissipation through-hole communicating with inside of the molded body is formed on a groove bottom portion corresponding to a position of the LED chip of the light emitting tube.

A backlight illumination system for a molded body according to another claim of the present invention, comprises: a molded body that is facing a frontside; an illumination element is arranged behind the molded body and illuminates a backside of the molded body; and a backside projection plate that is larger than an outline of the molded body and arranged far behind the illumination element to project light irradiated from the illumination element; wherein glass particles of which an outer surface is cut to be polyhedron is arranged to a predetermined position of an outer surface of the molded body.

A backlight illumination system for a molded body according to another claim of the present invention, wherein a backside projection plate comprises is made of a semitransparent film.

### Advantageous Effects of Invention

The invention according to the claims relates to a backlight illumination system, for a molded body, comprising: a molded body that is facing a front side; an illumination element that is arranged behind the molded body and illuminates a backside of the molded body; a light-through-hole that is arranged in a backward direction from the illumination element; and a backside projection plate is larger than an outline of the molded body and is arranged far behind the illumination element a to project light irradiated from the illumination element; wherein light rays irradiated onto the backside projection plate from the illumination element emerges a whole outline of the molded body as backlight ray of reflection light from the backside projection plate, and wherein a front side of the molded body is visually impressed providing an aspect of solemn atmosphere in association with the backlight ray.

Therefore, the reflection light from the backside projection plate having a larger size than the outline of the molded body is interfered and shut off with the molded body as the counter light ray, so that the frontside of the molded body is viewed in a dark atmosphere (space). On the contrary, in the circumference thereof, there is an effect that the backlight and the non-interference light are coupled with each other and the whole outline of the molded body is clearly emerged, thereby religious and spiritual solemn atmosphere exceeding the front shape of the molded body can be brought forth. Further, there is an effect that it is not necessary to assemble the illumination element in the molded body, therefore the form of the molded body can be freely formed, as a result, the form having religious and spiritual significance can be obtained.

According to another aspect of the present invention, the light emitting tube is surrounded by right and left side planes and bottom plane of the groove portion and heat of the LED chip is exhausted from the heat dissipation through-hole positioned at the rear plane of the LED chip, thereby cooling down of the LED chip can be efficiently conducted. Therefore, there is an effect by which light image projected on the backside projection plate can be variously changed by changing the form of the light emitting tube, luminous efficiency becomes good and backlight illumination to the molded body can be stably conducted.

According to another aspect of the present invention, the glass particles of which an outer surface is cut to into a polyhedron shape, is arranged at a predetermined position of the outer surface of the molded body, therefore, in addition that light leaked out from the molded body and the predetermined projecting light from the light-through-hole are projected on the projection plane positioned to the side direction, light from inside of the glass particles of which the outer surface is cut to polyhedron is passed, thereby scattered light diffused by irregular reflection is projected on the projection plane such as the backside projection plate, ceiling plane, floor plane, wall plane and the like and it is formed light object in which the projected light is complexly superimposed, as a result, the light illusion can amuse doubly the viewer.

Further, the glass particles can be embedded in the concave portion formed on the surface of the molded body, thereby fixation of the glass particles can be certainly conducted, and a faint light can be diffused from the inner bottom plane of the concave portion through the glass particles.

According to another aspect of the present invention, the backside projection plate comprises the semitransparent film, therefore there is an effect by which the image projected by the projector device, which is separately provided, is projected on the rear plane of the semitransparent backside projection plate and the composite image superimposed with light of the illumination element can be displayed on the backside projection plate.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a front view of a backlight illuminator for a molded body.

FIG. 2 is a side view of the backlight illuminator for the molded body.

FIG. 3 is a rear view of the backlight illuminator for the molded body.

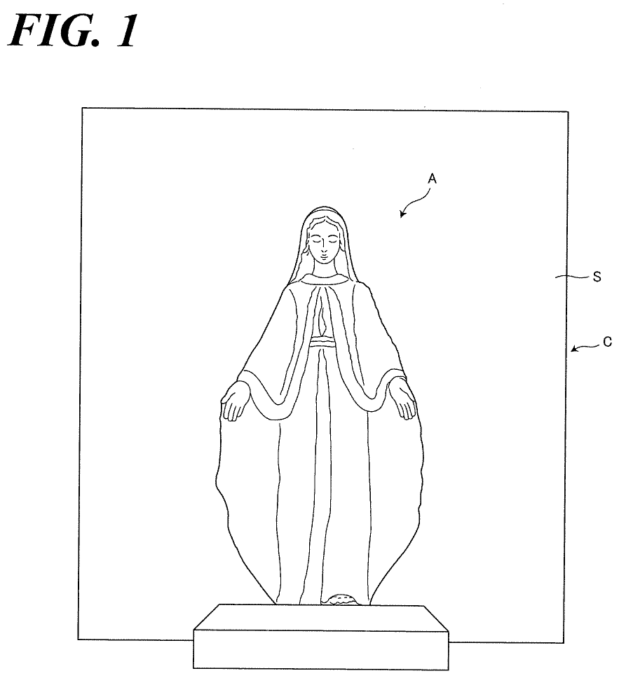

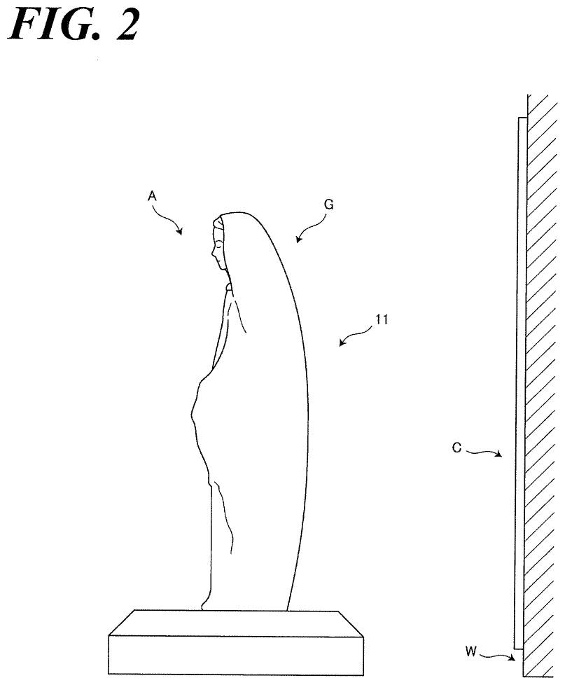

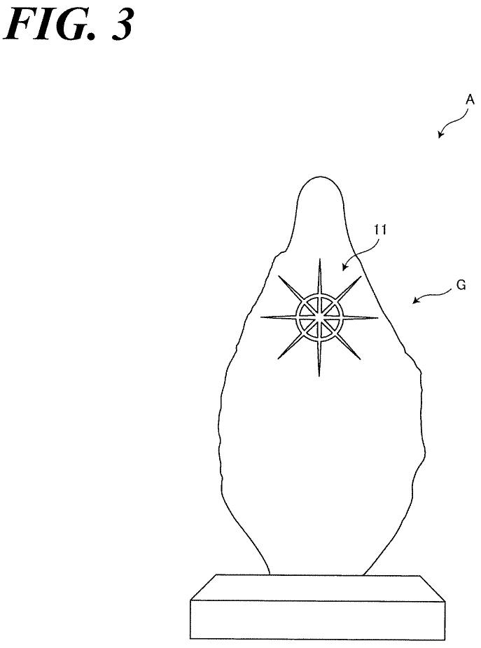

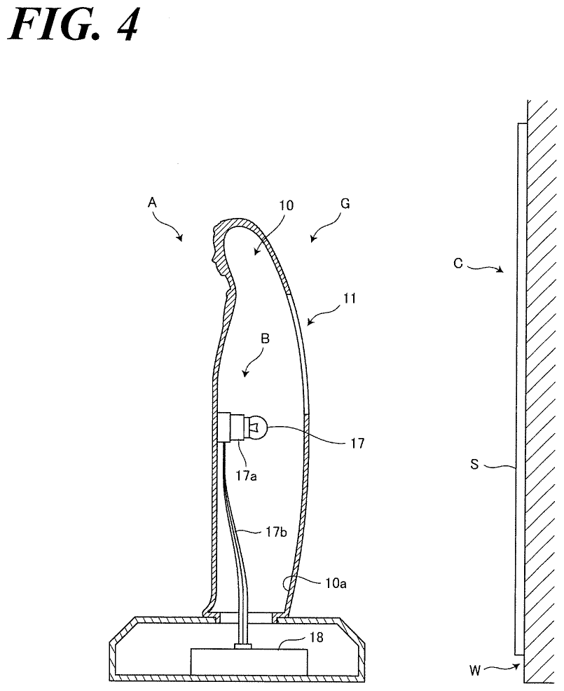

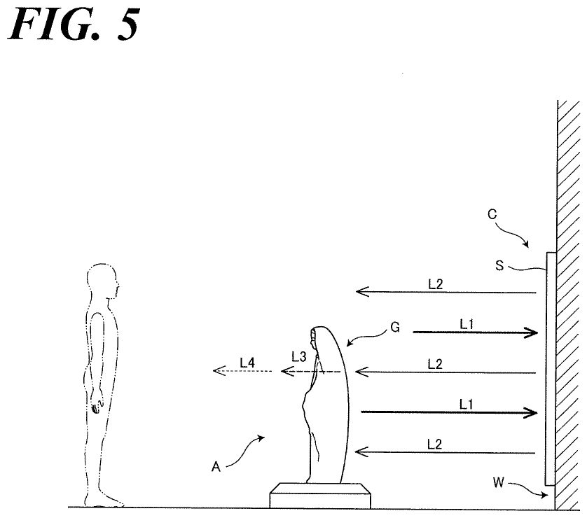

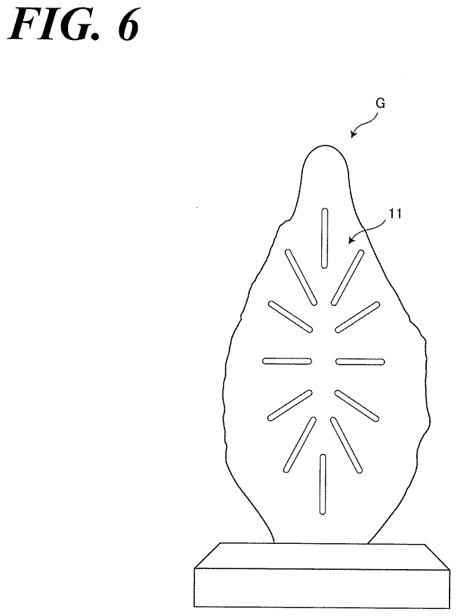

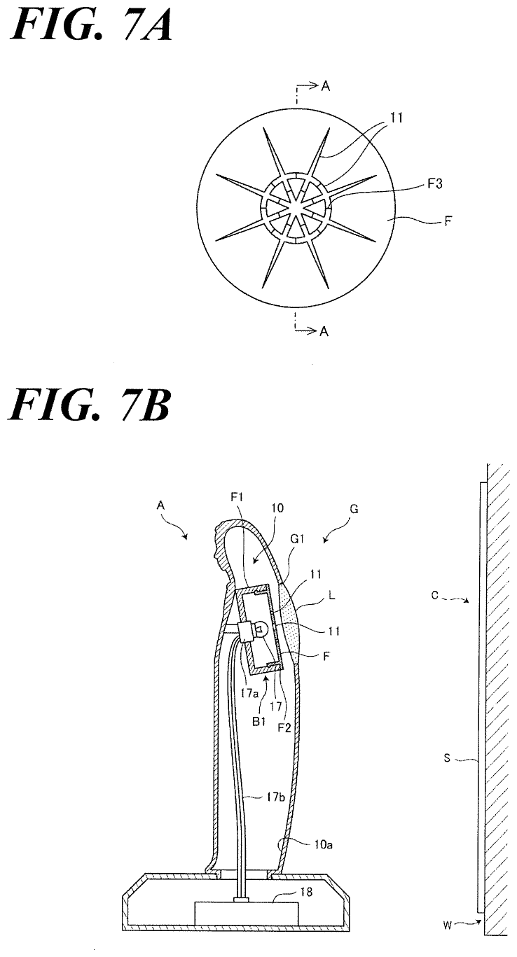

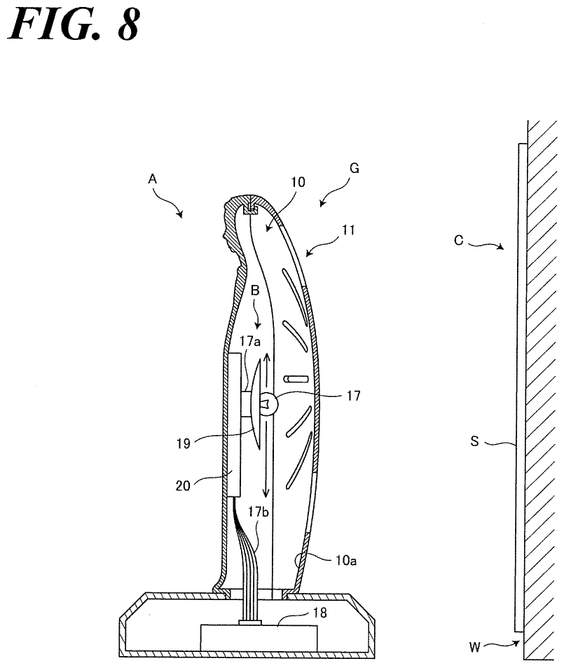

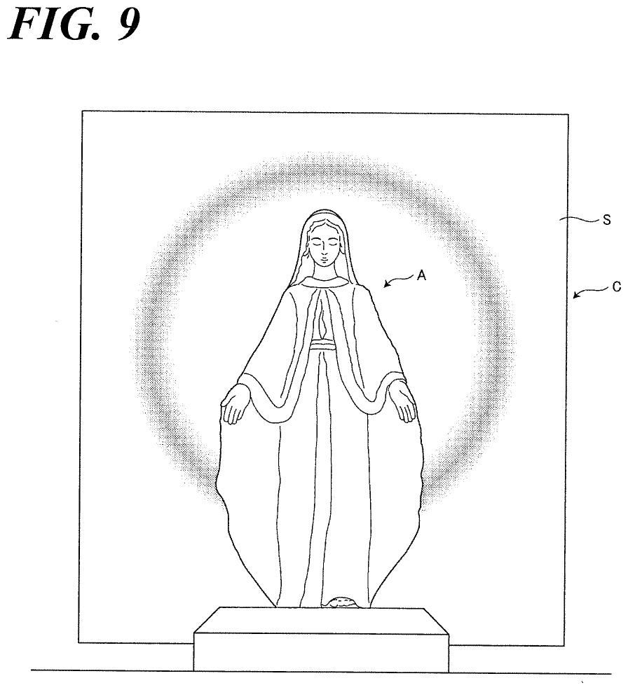

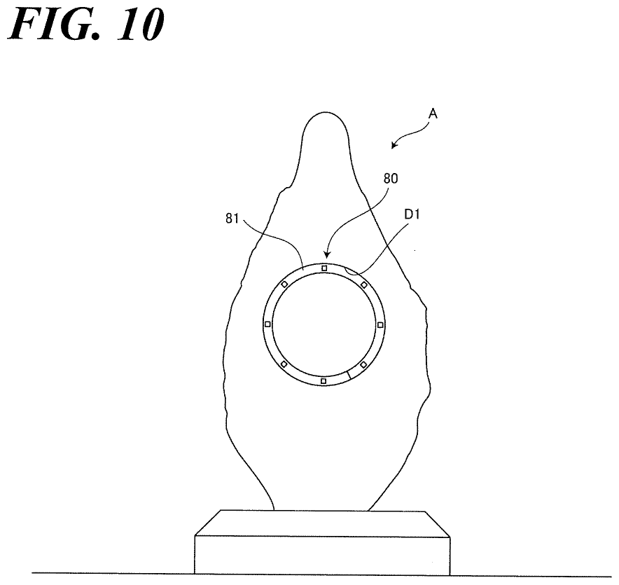

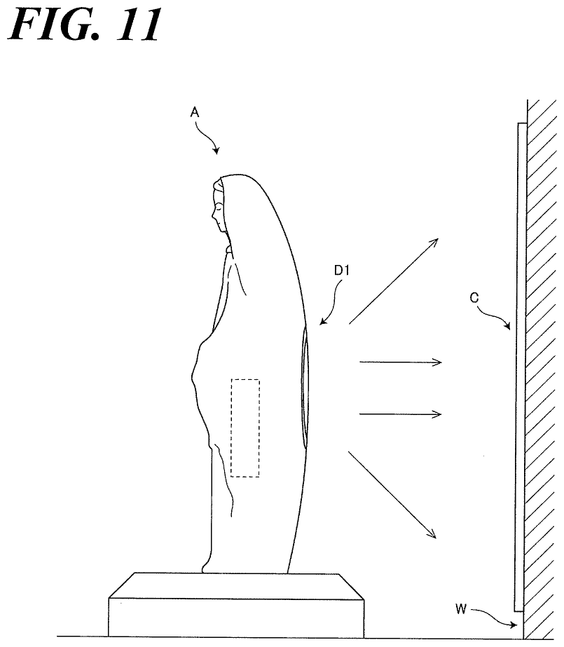

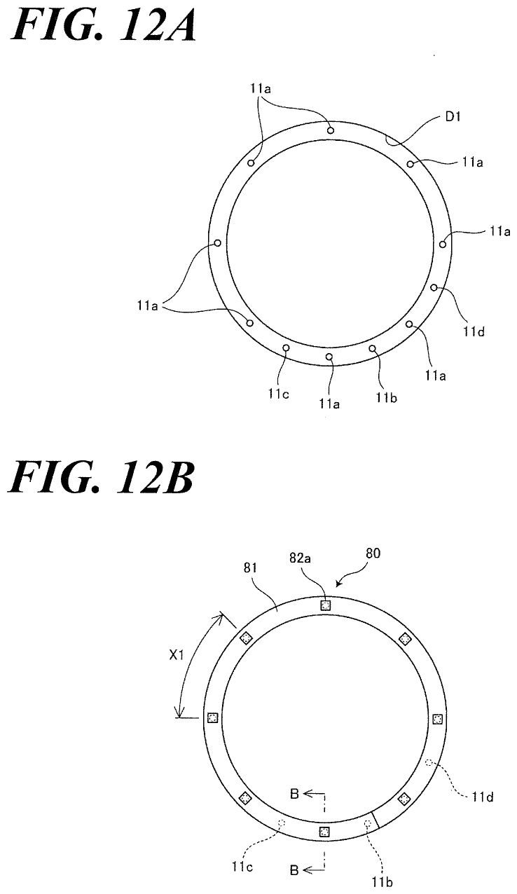

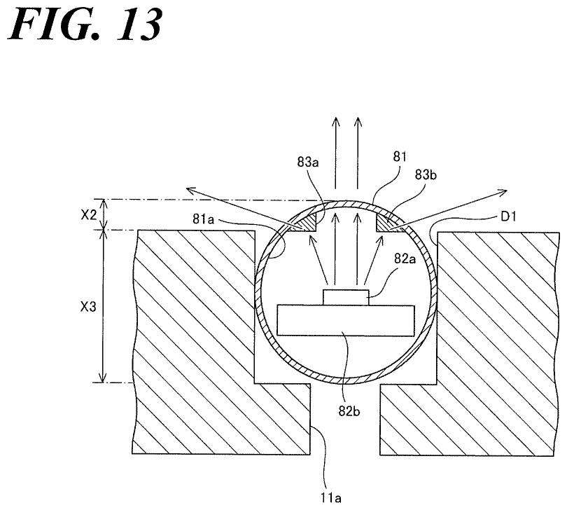

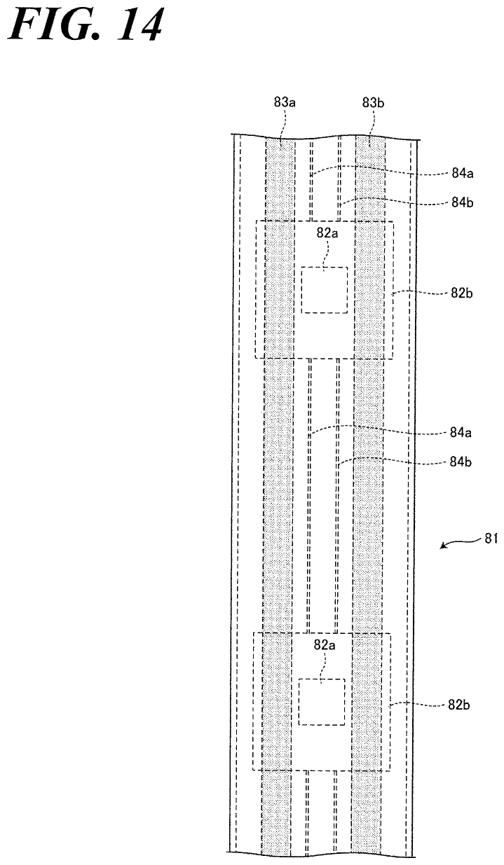

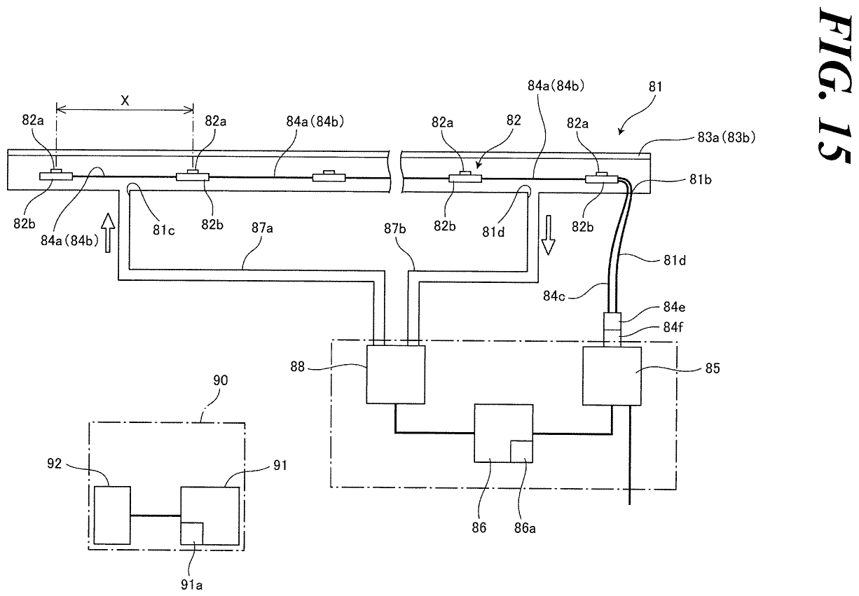

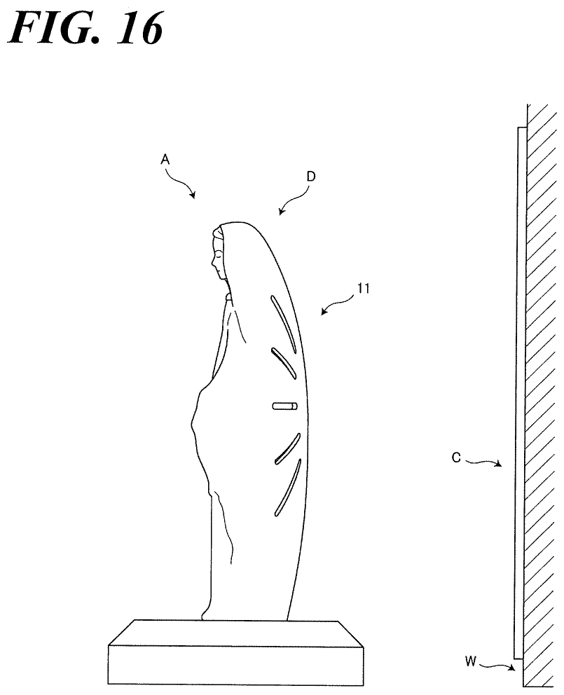

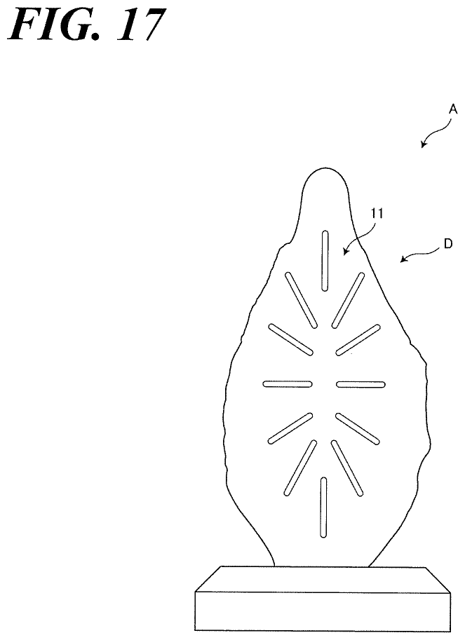

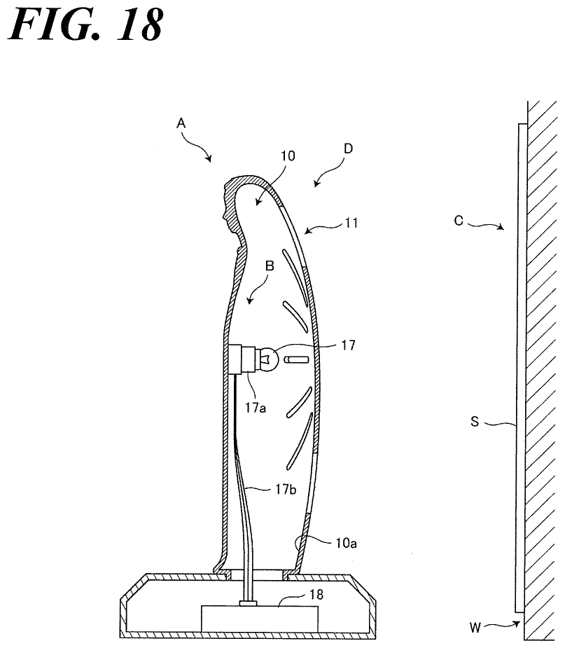

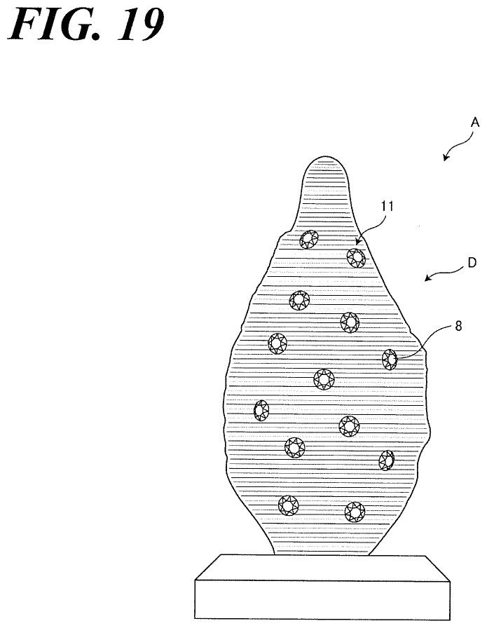

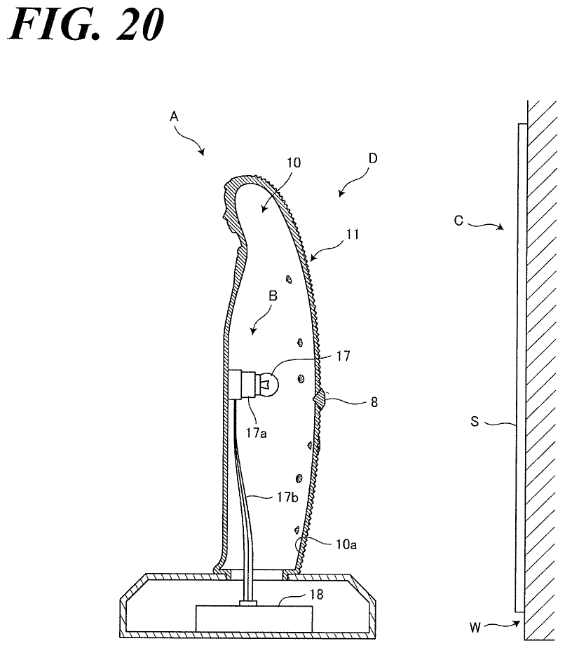

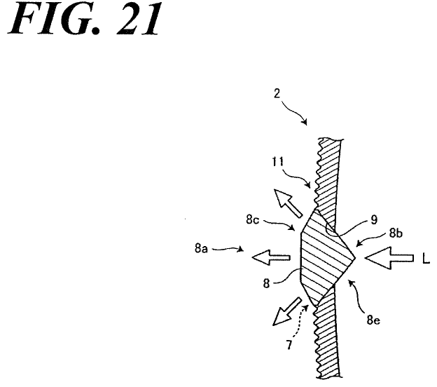

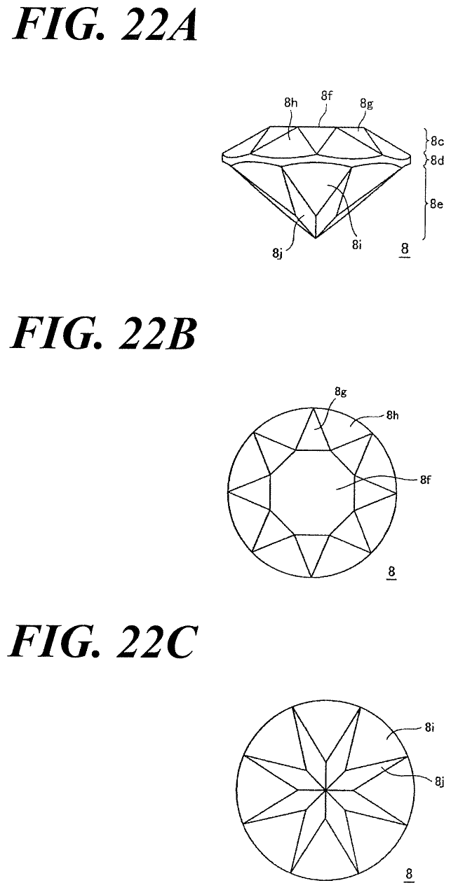

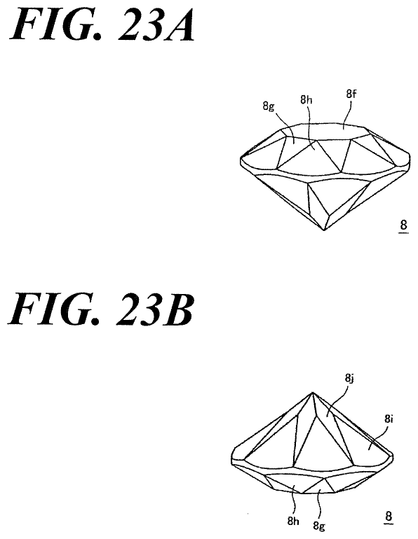

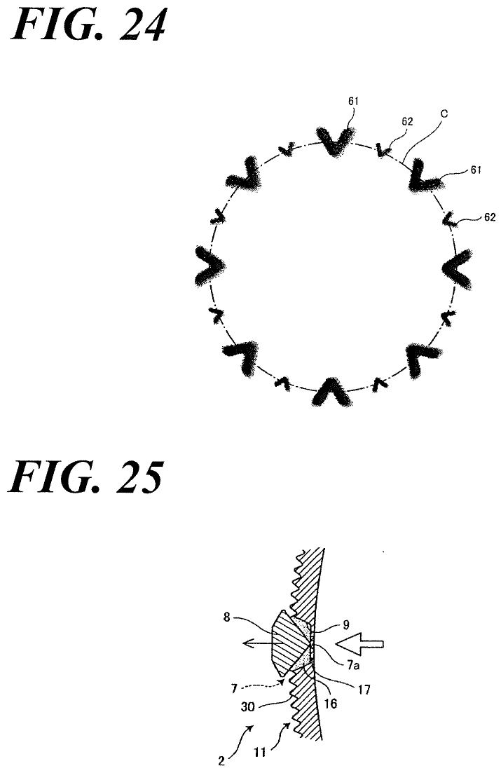

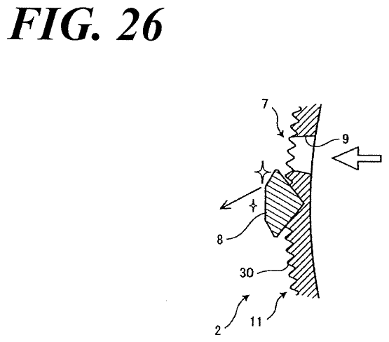

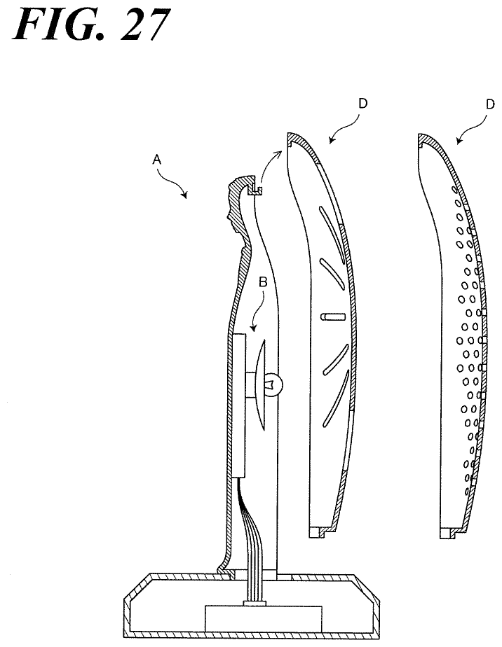

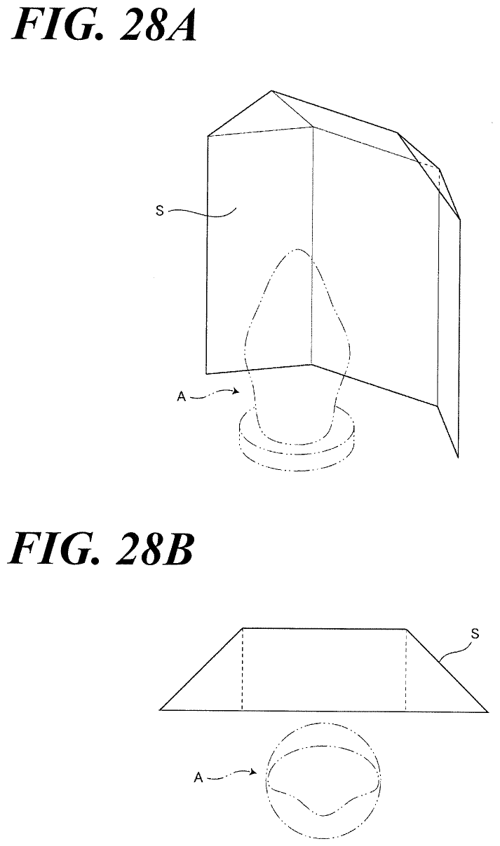

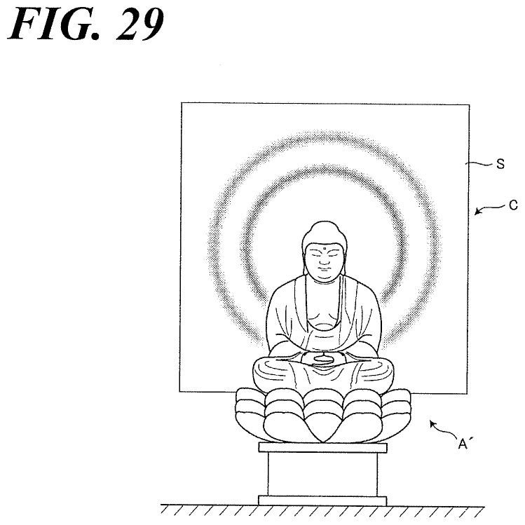

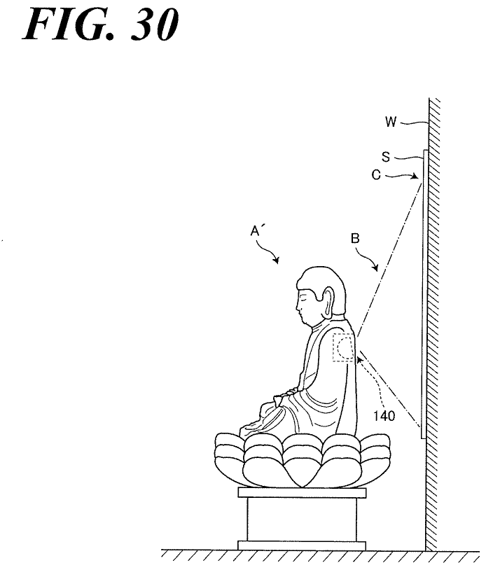

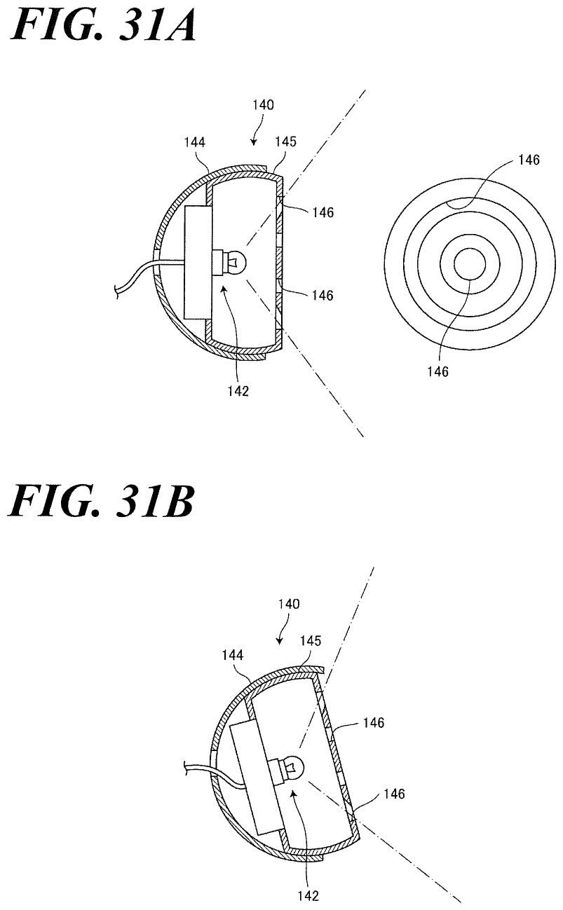

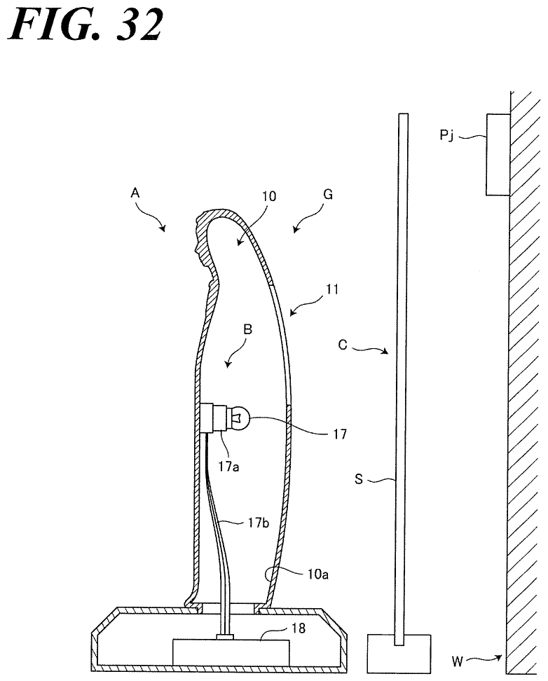

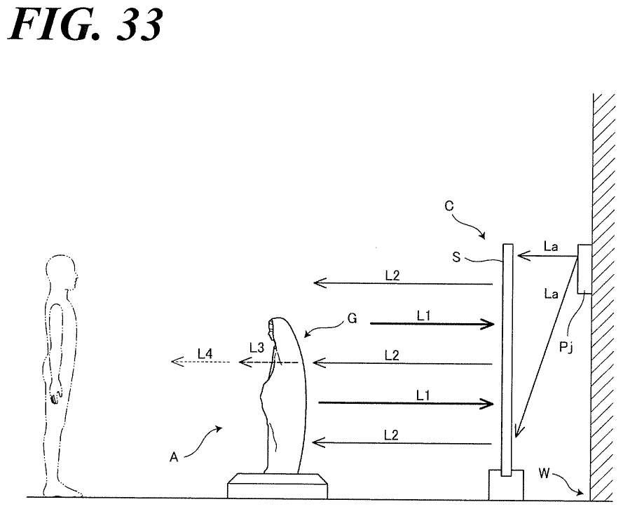

FIG. 4 is a sectional explanatory view of the backlight illuminator for the molded body.

FIG. 5 is a schematic view showing light dispersion from an illumination element.

FIG. 6 is a rear view showing a shape of light-through-hole.

FIG. 7A is a front view of an illuminator.

FIG. 7B is a sectional view of the illuminator incorporated in the molded body.

FIG. 8 is a sectional explanatory view of the other illuminator.

FIG. 9 is a front view of the other backlight illuminator for molded body.

FIG. 10 is a rear view of the other backlight illuminator for molded body.

FIG. 11 is a side view of the other backlight illuminator for molded body.

FIG. 12A is front view showing an annular groove and through-holes formed on a rear plane of the molded body.

FIG. 12B is a front view of a tube body embedded in the annular groove.

FIG. 13 is a B-B sectional view in FIG. 12B.

FIG. 14 is a plan view showing a main part of the tube body.

FIG. 15 is a constitutional view showing the other backlight illuminator for molded body.

FIG. 16 is a side view of the other backlight illuminator for molded body.

FIG. 17 is a plan view of the other backlight illuminator for molded body.

FIG. 18 is a sectional explanatory view of the other backlight illuminator for molded body.

FIG. 19 is a rear view of the backlight illuminator for molded body in which glass bodies are embedded.

FIG. 20 is sectional explanatory view of the backlight illuminator for molded body in which glass bodies are embedded.

FIG. 21 is a sectional view showing a form in which the glass particles is adhered in a concave portion of a lamp shade.

FIG. 22A is a front view of the glass particles.

FIG. 22B is a plan view of the glass particles and FIG. 22C is a bottom view of the glass particles.

FIG. 23A is a perspective view of the glass particles.

FIG. 23B is a perspective view of the glass particles.

FIG. 24 is a view representing a projected image radiated from cut planes of the glass particles.

FIG. 25 is a sectional view showing a second form in which the glass particles is adhered in the concave portion of the lamp shade.

FIG. 26 is a sectional view showing a third form in which the glass particles is adhered in the concave portion of the lamp shade.

FIG. 27 is a perspective view showing that the molded body and a backdrop molded body are mutually detachable.

FIG. 28A is a front view showing the other backside projection plate.

FIG. 28B is a plan view showing the other backside projection plate.

FIG. 29 is a front view of the other backlight illuminator for molded body.

FIG. 30 is a side view of the other backlight illuminator for molded body.

FIG. 31A is a sectional view of the other illumination element.

FIG. 31B is a sectional view of the other illumination element.

FIG. 32 is a side view of the backlight illuminator for molded body utilizing a semitransparent backside projection plate.

FIG. 33 is a schematic view in which light or image is projected on the semitransparent backside projection plate from the illuminating body and a projector.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

It will be further understood by those of skill in the art that the apparatus and devices and the elements herein, without limitation, and including the sub components such as operational structures, circuits, LED's, light commonents, wires power supplies, control elements of all kinds, display circuits and display systems and elements, any necessary driving elements, sensors, detectors, memory elements, microprocessors and any combinations of these structures etc. as will be understood by those of skill in the art as also being identified as or capable of operating the systems and devices and subcomponents as noted herein and structures that accomplish the functions without restrictive language or label requirements since those of skill in the art are well versed in related backlight illuminator system field(s) and all their sub components, including various circuits and combinations of circuits without departing from the scope and spirit of the present invention.

Although only a few embodiments have been disclosed herein, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art.

The embodiments of this invention will be described based on the drawings.

The backlight illuminator (illumination system) according to the present invention is basically formed by combining a molded body A facing the front, an illumination element B provided behind the molded body A for illuminating a rear portion of the molded body A and a backside projection plate C arranged behind the illumination element B on which light from the illumination element B is projected, and if necessary, a backdrop molded body D is integrally formed with the rear portion of the molded body A facing the front.

FIGS. 1 to 4 are respectively the front view, the side view, the rear view and the sectional explanatory view representing a constitution of the main embodiment according to the present invention.

The present invention includes the molded body A, the illumination element B and the backside projection plate C.

The molded body A is a standing statue and/or a sitting statue basically embodying religious or spiritual thought.

As the molded body A facing the front, for example, a statue of Virgin Mary (for example, see FIGS. 1 to 4), a Buddha statue (for example, see FIGS. 29 and 30), a Christ statue, a statue of God and a Kannon statue are conceivable, but the molded body A is not limited to such statues and it may be conceivably animals or buildings relating to a religious and spiritual thought. Further, for example, it may be conceivably a crane, a dragon and a giraffe or a building such as a western representative church, a cross and a crown.

The molded body A is made of ceramics, porcelain, synthetic resin, metal and glass and the like, but the material of the molded body A is not limited thereto.

Also, an interior of the molded body A is formed as a hollow or a mass of which the interior is filled, if needed.

As mentioned later, a variety of such structures can be selected according to a structure of which the illumination element B is installed on the rear portion thereof.

Hereinafter, it is described that a structure of the molded body A is formed as a hollow thereinside and the rear portion thereof is opened, further a lid (cover) G is detachably provided to an opened portion.

The hollow portion of the molded body A houses the illumination element B illuminating the rear portion of the molded body.

The illumination body (element) B comprises, for example, a lamp of filament type, a LED, an extremely small projector and the like.

According to one embodiment, the illumination element B comprises an illumination device including an integrally formed filter, in which light-through-holes are formed and arranged in a rear illuminating direction of the illumination element (to be mentioned later), and a light source, and according to another embodiment, in which a plurality of LEDs is built in a hollow tube to form a light emission tube.

As for the illumination element B, a variety of structures including such as a form, in which the illumination element B is housed in a hollow inner portion of the molded body A, and a form, in which the illumination element B is installed on the rear of the molded body A internally filled, is conceivable.

The backside projection plate C to project irradiation light is arranged far behind the illumination element B. The backside projection plate C is larger than the outline of the statue of Virgin Mary of the molded body A arranged in front of the backside projection plate C as if protruded. Specifically, a width in the right-and-left direction of the backside projection plate C is made larger than a width of the molded body A and a height in the up-and-down direction of the backside projection plate C is made larger than a height of the molded body A. As mentioned, based on that the backside projection plate C is designed larger than the molded body A, an irradiation light irradiated from the rear plane of the molded body A is largely projected on the backside projection plate C so as to protrude to the outside of the outline of the molded body A.

As the backside projection plate C, for example, a wall plane, a floor plane or a ceiling plane of building, screen board, semitransparent film and the like can be utilized.

For example, when that the backside projection plate C is formed of the screen board, the irradiation light of the illumination element B can be efficiently reflected onto the molded body A side as the backlight ray.

According to the structure comprising the molded body A, the illumination element B and the backside projection plate C, when the illumination element B is turned on, an indirect light of backlight ray from the backside projection plate C, which is arranged behind the molded body A, and is formed larger than the molded body A is irradiated to the molded body A such as the statue of Virgin Mary or Buddha statue having religious tone, the whole outline of the molded body A is emerged along with the backlight ray, distinct light atmosphere of the shape of the molded body A is brought forth. Further, religious and spiritual atmosphere exceeding only molded shape can be given to the front face shape itself of the molded body A through indirect light leaked out in molded body periphery from the backlight ray.

Furthermore, as a structure to install the illumination element B to the molded body A, an structure aspect to irradiate light only to the rear of the molded body A or a positional structure, in which the light from the light emission tube is irradiated in the backward direction and also in the backward-oblique direction of the molded body, can be utilized.

Hereinafter, a concrete structure that installs the illumination element B to the molded body A is described.

As shown in FIGS. 1 to 4, inside of the molded body A is formed as a hollow, the illumination element B is housed inside the hollow of a rear opening and the lid G is detachably provided to the rear opening to close it.

In the lid G, a light-through-hole 11 is formed, so that light from the illumination element B can be irradiated.

When the illumination element B is turned on, predetermined light passing through the light-through-hole 11 is irradiated on the backside projection plate C arranged behind the rear portion of the molded body A, a predetermined light image by light is projected on the backside projection plate C so that a light image is reflected forward from the backside projection plate C and recognized as the backlight ray from the rear of the molded body A by a viewer, so that religious and spiritual thought or religious shape of the molded body A that is irradiated from the rear by the backlight ray and a display function of religious atmosphere and/or religious shadow as well as beauty of the molded body A can be brought in reality.

Specifically, as shown in FIG. 5, light L1 from the illumination element B passes the through-hole 11 of the lid G installed on the rear plane of the hollow molded body A and is irradiated on a screen board S, so that a light image of the through-hole 11 is projected. Thereafter, the light L1 from the illumination element B is reflected on the screen board S and becomes the backlight ray L2. Thereby, faint light of the backlight leaked out forward without being interfered with the statue of Virgin Mary of the molded body A projects facial expression of the statue of Virgin Mary of the molded body.

Further, although the backlight ray L2 from the screen board S is interfered with the statue of Virgin Mary and the frontside of the statue of Virgin Mary becomes shade portion of shadow of the backlight ray, the backlight ray L2 becomes non-interference light in periphery of the statue of Virgin Mary within the backlight shadow and light L3 dispersed in outer periphery of the molded body A couples with the backlight shadow of the statue of Virgin Mary. Thereby, light L4 emerges the outline of the statue of Virgin Mary, thus solemn atmosphere of the statue of Virgin Mary can be brought forth by light. Here, the light-through-hole 11 may be constituted in the rear portion of the molded body A. When the semitransparent film is utilized as the backside projection plate C, a variety of light presentations can be performed by projecting the composite image combined by superimposing images projected from an separately equipped projector while projecting the light image of the light-through-hole 11.

A shape of the light-through-hole 11 formed on the lid G can be a variety of shapes while considering the shape of a kind of light projected on the backside projection plate C or an aspect of reflection light and the like.

For example, when a plurality of long holes is radially formed, the viewer can view radial light images formed by the plural long holes as after shade of the molded body A. Further, the reflection light thereof is viewed by the viewer as the backlight ray from the rear of the molded body A, so that religious and spiritual significance (impression) of the shape of the molded body A can be produced in the light shadow.

Here, although a normal illumination lamp 17 is utilized as the illumination element B, a change in light irradiating from the light-through-hole 11 by devising filament shape of the lamp can be given. The reference 17a in FIG. 4 is a socket of the illumination lamp 17, the reference 17b is electric wiring and the reference 18 is a power supply supplying electricity to the illumination lamp 17.

Various shapes of light trough hole

Especially, based on that the shape of the light-through-hole 11 formed in the lid G is variously changed, the shape of the light projected on the backside projection plate C is also variously changed, by which a religious and spiritual atmosphere due to the molded body A can be further changed.

For example, as mentioned above, the light-through-hole 11 is formed in 12 long holes and the long holes are radially arranged, so that a radial light image can be projected on the screen.

Further, as shown in FIG. 7, the illumination element of the molded body A may also be a box-type filter F1.

Specifically, the box-type filter F1 embedding the illumination lamp 17 is formed, a frontside opening portion F2 is formed in the filter body F1, a design filter F forming a light image is arranged in the frontside opening portion F2 and the design filter F comprises the light-through-hole 11, a circular hole and a plurality of radial long holes.

Further, the illumination element may be made of an extremely small projector.

Specifically, when the design filter F in which the light-through-hole 11 is formed is exchanged, change in various image lights can be enjoyable on watching the screen according to a variety of kinds of light-through-hole 11.

Further, when a lid opening portion G1 is formed in a part of the lid G and a retractable lens mechanism L is installed in the lid opening portion G1, an imaging distance for an image between the illumination lamp 17 within the inside of the molded body A and backside projection plate C can be adjusted, thereby an image from the light-through-hole 11 can be clearly projected even when the distance to the backside projection plate C is short.

Here, the box-type filter body F1 may be continuously provided on the rear plane of the molded body A without being housed within the hollow inside the molded body A, or the box-type filter body F1 may be provided in between the screen and the backside of the molded body.

Further, as shown in FIG. 8, in the illumination element B, a reflection mirror 19 is arranged behind the illumination lamp 17, so that light amount emitted from the light-through-hole 11 can be increased through the reflection mirror 19. Furthermore, light amount of the backlight ray from the screen S is increased, so that facial expression of the statue of Virgin Mary of the molded body can be still more projected by faint light of the backlight leaked out forward without being interfered with the statue of Virgin Mary of the molded body A.

In addition, although the backlight ray L2 from the screen board S is interfered with the statue of Virgin Mary and the front face of the statue of Virgin Mary becomes the shade portion in the shadow of the backlight ray, the non-interference light in periphery of the statue of Virgin Mary in the backlight shadow illuminates the statue of Virgin Mary from the side and the frontside, so that the light L3 dispersed in outside of the backdrop molded body D emerges the outline of the statue of Virgin Mary while coupling with the backlight shadow of the statue of Virgin Mary and solemn atmosphere of the statue of Virgin Mary can be brought forth. Further, when the box-type filter body F1 is not housed in the hollow inside of the molded body A, i.e., the box-type filter body F1 is arranged in between the screen and the statue of Virgin Mary (molded body), the effect as same as the above effect can be obtained.

Further, as shown in FIG. 8, the illumination lamp 17 of the illumination element B is provided inside the molded body A so as to become movable up-and-down along an inner wall plane of the molded body A.

Specifically, a rail 20 is installed on the inner wall of the molded body A so that the illumination lamp 17 becomes freely movable, and the socket 17a is provided so as to become movable up-and-down along the rail 20.

Based on that the above structured illumination element B moves up-and-down along the rail 20, a light direction and an amount of light irradiated from each light-through-hole 11 changes and the amount of light dispersed outside the backdrop molded body D changes in the up-and-down direction. Therefore, the light image projected on the backside projection plate C is brightened up in the up-and-down direction and the religious atmosphere of the molded body A can be even more brought forth to the viewer in the backlight atmosphere for the molded body A.

Here, it may be conceivable that a back-and-forth rail mechanism is provided in the hollow inside the molded body A which is movable both up-and-down direction and back-and-forth direction.

As mentioned, based on that it is provided the back-and-forth rail mechanism through which the illumination element B becomes movable in the back-and-forth direction, light amount dispersing in outside direction of the backdrop molded body D can be changed in the back-and-forth direction, so that brightness of the image projected on the backside projection plate C can be adjusted in cooperation with movement in the up-and-down direction.

Without especially housing the illumination element B within the hollow molded body A, a light emitting tube 80 can be provided on the rear plane of the molded body A, instead of the illumination lamp 17 of the illumination element.

Specifically, the light emitting tube 80 can be installed on a surface of the hollow molded body A or to the rear plane of the molded body A internally filled.

Concretely, as shown in FIGS. 9 to 15, an annular groove D1 is formed on the rear portion of the molded body A internally filled or the hollow molded body A and the light emitting tube 80 is embedded within the annular groove D1. The light emitting tube 80 is formed so that LED chips 82a are built within the transparent or semitransparent hollow light emitting tube 81 at regular intervals.

On a groove bottom portion of the annular groove D1, through-holes 11a for heat dissipation communicating with an exhaust heat space formed in the molded body A are formed at regular intervals, so that light emitting heat of the light emitting tube 80 can be structurally exhausted.

A LED illumination lamp 82 (see FIG. 15) electrically connected to a LED chip 82a mounted on a heat dissipating board 82b and refractors 83a, 83b, having the high refractive index for side emission, are built in the hollow portion of the tube 81.

As shown in FIG. 15, the LED illumination lamp 82, in which a plurality of LED chips 82a are connected through internal wirings 84a, 84b, is connected to a power source 85 for driving. Further, a main control unit 86 to control dimming and lighting interval of LEDs based on signals from an external controller 90 is connected to the power source 85. In the figure, the reference 81a is an inner wall of the tube body 81, the reference 81b is a wiring hole. The references 84c, 84d are wirings, the references 84e, 84f are electric connectors, the reference 91 is a sub-unit-control unit, the reference 91a is a call chip and the reference 92 is a battery.

Further, in a midway lower-part in the right-and-left direction of the tube body 81, an air supply hole 81c and an air discharging hole 81d for supplying and discharging air to cool down inside of the tube body 81 are respectively drilled and installed.

On the inner wall of the tube body 81, side-emission-refractors 83a, 83b, respectively having a substantial triangle-shape, are formed in the longitudinal direction on both walls except for the inner wall portion extending from the emitting planes of the LED chip 82 in the vertical direction. The refractors 83a, 83b for side emission are formed by dividing the refractor, which is formed as a substantial-circular arc in the sectional view thereof and has a high refractive index, into three parts.

The light emitting tube 80 can be operative for such as lighting up, lighting off, dimming and changing colors through the external controller 90.

In order to cool down the illumination lamp 82, an air supply unit 88 provided in the molded body A communicates with an air supply hole 81c formed in a lower portion of the tube body 81 through air supply pipe 87a and an air discharge hole 81d formed in a lower portion of the tube body 81 through an air supply hole 81c and an air discharge pipe 81b, so that an air communication takes place in the tube 81 and resulting in cooling down therefor. Here, the references 11c, 11d in FIG. 12A respectively indicates an air discharge drilled hole and an air supply drilled hole, thereby a terminal end of the air discharge pipe 87b and an end portion of the air supply pipe 87a are mutually communicated and connected. The reference 11b is a wiring drilled hole drilled on the bottom portion of the annular groove portion D1 and external wirings 84c, 84d of the LED illumination lamp 82 are inserted therein. The references 84e, 84f are connectors to connect the external wirings 84c, 84d and the power supply unit 85.

The tube body 81 is embedded so that a half circumference thereof protrudes from the annular groove portion D1 and the refractors 83a, 83b for side emission having high refractive index are built in the hollow inner wall of the tube body 81, especially in the inside corresponding to the external half circumference. Therefore, when the LED chip 82a is turned on, a part of emitted light is incident in the refractors 83a, 83b for side emission and is largely refracted. The light passing the protruded tube body 81 is emitted in an oblique rear direction along surface of the molded body A, so that the emitted and dispersed light gives shadow to the molded body and as a result, an effect due to an fantastic impression is given on the viewer.

The mentioned light emitting tube 80 is deformable due to the inherent property of the tube, by which the light emitting tube 80 is freely deformed e.g., for folding the light emission tube 80 to make a shape so that the light emission aspect to the backside projection plate C can be freely changed in the rear plane of the statue of Virgin Mary of the molded body A.

Further, if necessary, the light emission tube 80 can be installed so as to surround a body part, a leg part and/or a neck part of the molded body A. As mentioned, except that the light emission tube 80 is solely installed in a plane to the rear plane of the molded body A, the light emission tube 80 is stereoscopically deformed and light irradiation to the molded body A is conducted not only by irradiating the backlight ray from the backside projection plate C and but also by directly and stereoscopically irradiating light from the light emission tube 80. Thereby, religious and spiritual significance of the molded body A can be further boosted.

Here, material of the tube body may be semitransparent material other than transparent material.

Further, the illumination element can be embedded in the space formed in the backside of the molded body A.

Next, an illumination element 140 shown in FIGS. 29 to 31 possesses a mechanism capable of freely projecting patterns of light projected on the backside projection plate C in the up-and-down and right-and-left directions and the mechanism includes a light source lamp 142 built therein, a hemispherical body 144 and a rotating body 145 rotatable along an inner circumference of the hemispherical body 144.

The rotating body 145 has a curved structure capable of freely rotating along the inner circumference of the hemispherical body 144 and the rotating body 145 can rotate along the inner circumference of the hemispherical body 144 in the up-and-down and right-to-left directions, so that positions of various patterns of light on the backside projection plate C can be freely changed. The reference 146 in FIG. 31 is a ring shape transparent glass embedded in a ring shape light-through-hole formed in the rotating body 145.

The illumination element 140 is embedded in the space formed in the backside of the Buddha statue in the Buddha statue A′ shown in FIGS. 29 and 30. The illumination element 140 is embedded in the space of the backside of the Buddha statue, so that the Buddha statue with a good appearance can be obtained.

The backside projection plate C is arranged behind the molded body A, i.e., arranged in the irradiating direction of the illumination element B.

The backside projection plate C may be integrally formed with the molded body A or may utilize a wall plane of building structure or may be a screen vertically installed behind the molded body A. In brief, the backside projection plate C is just what projects the light emission from the illumination element B, the backside projection plate C forms a rear scene of the molded body A through light patterns, fulfills a function to recognize the viewer a distinct atmosphere scene including rear light of the molded body A coupling with the molded body A and in addition, brings forth atmosphere with distinct shadow to the molded body A as the backlight ray.

The molded body A, the illumination element B and the backside projection plate C in the embodiment are structured as described above, and hereinafter a backdrop molded body D as the technology concerning the other embodiment will be described in detail.

Although, in the mentioned embodiment, the structure housing the illumination element in the hollow inside the molded body and the structure in which the illumination element is installed on the rear plane of the molded body are described, another embodiment other than such structures, in which a backdrop molded body is independently attached to the rear plane of the molded body and an illumination element is provided in the backdrop molded body.

As shown in FIGS. 16 to 18, the backdrop molded body D is a hollow and substantially semispherical structure, which is attachable to the rear plane of the molded body A and the light-through-hole 11 with a predetermined shape, is formed on the circumferential wall thereof and further the illumination element B is housed inside the hollow.

Given the molded body A is made for the standing statue of Virgin Mary, a half-statue of Virgin Mary, in which a frontside of the statue of Virgin Mary is kept and the backside of the statue of Virgin Mary is expunged, comprises the backdrop molded body D, which is a vertically cut and substantially half cone or a hemisphere, is attached to the backside thereof.

Further, as shown in FIG. 18, the backdrop molded body D comprises a hollow 10 capable of housing the illumination element B therein and the light-through-hole 11 having holes with various shapes is formed on a wall plane 10a of the backdrop molded body D.

The shape of this light-through-hole 11 is as the same as the light-through-hole 11 already formed on the lid G of the hollow-molded body A. Thus, the light-through-hole 11 can be formed in various shapes following many requirements such as the shape of the molded body, the significance thereof, kinds of backlight into consideration.

Glass particles, of which outer surface is cut to make polyhedron, are disposed on a predetermined position of the wall plane 10a of the backdrop molded body as described above.

Hereinafter, an embodiment is described, in which glass particles are arranged at a predetermined position of the backdrop molded body, referring FIGS. 19 to 26.

In the present embodiment, it is characterized by that a glass particles, for example, a Swarovski body is embedded or adhered to the rear portion of the molded body A, i.e., the circumferential wall of the backdrop molded body D or light-through-hole and further, it may be expressed colors in projecting light by coloring the glass particles.

Irregular reflection function of the glass particles does not have only light reflection function and when light is projected to projection planes arranged near, a light source shape of the illumination lamp 3 is projected so that such shape becomes as same as a projected shape from many lights through-holes and becomes a small-scale image. Moreover, many images are projected according to a number of cut-planes in the glass particles.

Hereinafter, referring to the drawings, a structure in which the glass particles are arranged to the backdrop molded body surface of ceramics, on which glaze is not applied, is set forth.

As shown in FIGS. 19 to 21, many concave portions 7 are formed in the circumference wall 11 of the backdrop molded body and the glass particles 8 are embedded in each of the concave portions 7.

In the other embodiment, a bottom portion of the concave portion 7 is opened, so that a through-hole 9 is formed at the bottom portion, and therefore, the concave portion 7 is communicated with the inside of the backdrop molded body D. The opening portion is a funnel shape (see FIG. 26).

Further, in the other embodiment, a thin film 7a (see FIG. 25) is stretched in the bottom opening portion of the concave potion 7 on an opening 9.

Here, the thin film 7a is formed in about 1 mm thickness and resin 16 having high permeability is impregnated in the thin film 7a. Further, the glass particles 8 are adhered to the thin film 7a.

The glass particles 8 are made of transparent material capable of irradiating light incident from a bottom surface 8b from polygonal surface of a front surface 8a. The glass particles 8 are colored in many colors including such as red, blue, yellow, green and the like, in addition to transparent material.

Here, material of Swarovski body including more than 24% of lead oxide in glass has high transparency and more than 1.52 of refractive index.

A light reflection form of Swarovski particles 8 are described in FIGS. 22 and 23. Specifically, as shown in FIG. 21, when a light of light source from a pavilion 8e is incident, the light of one of the light sources is respectively incident to each of eight lower girdle facets 8i and each of sixteen lower main facets 8j. Further, the incident light is reflected within the Swarovski particles 8 and respectively irradiated outside from each of eight star facets 8g and each of eight upper main facets 8h. As shown in FIG. 24, large and small projection images 61, 62 having v-shaped scale with a thin-width are projected as an image in which large and small images are alternately juxtaposed on a virtual circle C and projected on the rear of the molded body A or a projecting plane body near the molded body A. In FIGS. 22 and 23, the reference 8d is a girdle portion.

As shown in FIG. 26, when a position separated from light-through-hole 22 by about 3 mm, e.g., a lower half of the glass particles 8, is embedded at a position near light-through-hole 22 of the backdrop molded body D, light from the light source passes the light-through-hole 22 is incident from a cut surface of a part of a crown portion 8c of the glass particles 8 and diffuses reflection, and the light is irradiated from a table 8f while shooting a weak sparkle.

Further, as shown in FIG. 27, the molded body A and the hemispherical backdrop molded body D may be made detachably. When the backdrop molded body D is integrally assembled with the rear plane of the molded body A, a close contact structure is adopted so that light of the illumination element B is not leaked out from the mating surface.

As mentioned, based on that it is constituted so that the backdrop molded body D is made detachable, various light images projected on the screen can be changed by exchange of the backdrop molded body D, thereby light production meeting viewer's preference can be conducted.

Further, by forming the light-through-hole with a predetermined shape on whole circumference of the backdrop molded body D, various light is diverged therearound from the side area of the outer circumference in the molded body, so that light projection can be conducted on the side wall plane standing with a predetermined angle against the backside projection plate, in addition to the rear direction.

For example, such as a light pattern of peacock pattern or light pattern of flower pattern is projected on the wall, so that an effect that beautiful light projection space can be formed in the whole space near the molded body while producing light change near the molded body.

Here, not only the backside projection plate is arranged in a plane behind the molded body, but also, as shown in FIG. 28, the backside projection plate is formed in U-shaped in plan-view or in mountain-shaped in plan-view and the projected light image is also projected on the backside projection plate C, so that a variety of changing images in the whole space can be also enjoyed.

As mentioned, when the light emitting tube 80 is installed on the surface of the backdrop molded body D, the annular grove portion D1 is formed on the rear plane of the backdrop molded body D and the light emitting tube 80, in which the LED chips are built in a hollow tube at regular intervals, is embedded in the groove portion.

On the groove bottom portion of the annular groove portion D1, the exhaust through-holes 11a communicating with the exhaust space formed inside of the backdrop molded body D are formed at predetermined intervals and the heat emitted by the light emitting tube 80 is exhausted.

In the embodiment described hereinafter, the semitransparent film is utilized as the backside projection late C. The embodiment possesses the constitution, wherein predetermined light passing the light-through-hole 11 on the backside of the molded body A is irradiated, thereby a predetermined light image by the light is projected, and at the same time, two images can be viewed from the frontside of the above film even if an image from the projector device arranged at the rear plane side of the above film is repeatedly projected. Here, in FIGS. 32 and 33, the same references as the above elements are attached and a doubled explanation will be omitted.

As shown in FIGS. 32 and 33, the semitransparent backside projection plate C is arranged between the rear plane of the molded body A and the wall plane W. Further, behind the backside projection plate C, the projector Pj is arranged. On the backside projection plate C, an image La projected from the projector Pj is projected on the rear plane of the semitransparent backside projection plate C and a composite image superimposed with the light L1 of the illumination element B is displayed. By utilizing the semitransparent projecting plate C, various kinds of light production can be conducted by rebuilding to the various composite images corresponding to an installation location (premise) of the molded body (e.g., a temple and a church).

Here, although the projector Pj is installed on the wall plane of the rear side of the molded body A, when the image can be projected on the rear plane or the frontside of the backside projection plate C, it is not necessary to especially limit the installation location.

Here, as for the semitransparent film, a black semitransparent film and a milky white semitransparent film can be included as long as the same function as the semitransparent film, i.e., the background can be seen through the film.

Here, in the above embodiment, the backside projection plate C is made in the semitransparent form, so that the composite image obtained by superimposing the light image of the illumination element and the image of the projector device can be carried out.

The backlight illuminator of the present molded body may be so as to possess operating function to move a hand, an arm, head, upper body as a robot function and further migrate, a bidirectional conversation function and a facial expression function to variously change facial expression corresponding to circumstance or conversation.

As mentioned in the above, although the preferred embodiments of the present invention are described, the present invention is not limited to such specific embodiments and various modifications and changes can be done within a scope of the present invention described in claims.

### REFERENCE SIGNS

A molded body (statue)
B illumination element
C backside projection plate
G lid
S screen board
W wall plane
10 hollow
11 hole (a light passes through.)

Also, the inventors intend that only those claims which use the words “means for” are intended to be interpreted under 35 USC 112. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1.-4. (canceled)

5. An illumination assembly system that provides a backlight to a molded body, comprising
a molded body having a first outer periphery and a first size and positioned in a first position;
said molded body having a front side and a rear side;
a light projection plate having a second outer periphery and a second size and positioned in a second position;
said light projection plate having a facing side extending to said second outer periphery;
said facing side of said light projecting plate facing said rear side of said molded body.
said second position of said light projecting plate being spaced from said said rear side of said molded body;
said second size and said second outer periphery of said light projection plate being larger than said first size and said first outer periphery of said molded body;
at least one light emitter affixed to said molded body;
said at least one light emitter emitting a backlight away from rear side of said molded body toward said facing side of said light projection plate and illuminating said light projection plate to said second outer periphery, whereby said backlight provides an illumination which is larger than said first outer periphery of said molded body.

6. The illumination assembly system, according to claim 5, wherein:
said at least one light emitter is installed said rear side of said molded body;
said light emitter further comprising:
a grove having a continuous shape;
a hollow tube in said groove;
a light emitting member within said hollow tube having a plurality of LED chips at regular intervals along said hollow tube to emit said backlight therefrom; and
a plurality of heat dissipation-through-holes along said groove proximate each respective one of said plurality of LED chips.

7. The illumination assembly system, according to claim 5, wherein:
said at least one light emitter is installed within said molded body between said front side and said rear side;
at least one opening in said rear side of said molded body and transmitting said backlight from said at least one light emitter through said at least one opening toward said facing side of said light projection plate and illuminating said light projection plate to said second outer periphery.

8. The illumination assembly system, according to claim 7, further comprising at least a plurality of said openings in said rear side of said molded body.

9. The illumination assembly, according to claim 8, wherein:
at least one of a transparent polyhedron, a semitransparent polyhedron, and a removable lens in ones of said plurality of openings in said rear side of said molded body.

10. The illumination assembly, according to claim 9, wherein:
said rear side of said molded body includes said at least one of said transparent polyhedron and said semitransparent polyhedron in said plurality of openings, and further comprises:
a semitransparent thin film covering said plurality of openings.

11. The illumination assembly, according to claim 5, wherein:
said light projection plate further comprises:
a semitransparent thin film.
